(19) United States
(12) Patent Application Publication
(10) Pub. No.: US 2007/0074469 A1
(43) Pub. Date: Apr. 5, 2007

(54) Entry door frame

(76) Inventors: Robb Plagemann, Roanoke, VA (US); Chad Schlemmer, Moorhead, MN (US); Todd Pringle, West Fargo, ND (US); Lee Assenheimer, Chicago, IL (US); Steve Syrdal, Fargo, ND (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/517,937

(22) Filed: Sep. 8, 2006

Related U.S. Application Data
(60) Provisional application No. 60/715,329, filed on Sep. 8, 2005.

(51) Int. Cl. E06B 1/04

(52) U.S. Cl. 52/204.1

(57) ABSTRACT

A door frame includes a pultruded profile extending from a first side to a second side and having a back wall and a front wall, the first side of the front wall having a recessed area, the second side including a mounting section to receive a wood board.

### CROSS-REFERENCE TO RELATED APPLICATION

This application claims the benefit under 35 U.S.C. 119 (e) of U.S. Provisional Application No. 60/715,329 filed on Sep. 8, 2005, which is hereby incorporated by reference in its entirety.

### FIELD

This application relates generally to building products and more specifically to a door frame.

### BACKGROUND

Entry door frames are typically wood assemblies with stain, paint or aluminum trim to provide weatherability and aesthetics. Less common are frames made of PVC or cellular PVC. Wood is prone to rot, expansion due to water absorption, and is susceptible to termite infestation. PVC based frames are prone to expansion and contraction due to PVC's high co-efficient of thermal expansion. PVC is also prone to lose rigidity and dimensional stability due to PVC's low heat deflection temperature. Aluminum, and other metals, used as door frames are prone to high thermal transfer due to metals high thermal conductivity and are thus energy inefficient. What is needed is an door frame that is insulating, resistant to termite infestations, resistant to rot, weatherable, dimensionally stable at temperature extremes, and aesthetically pleasing.

### SUMMARY

A door frame includes a pultruded profile extending from a first side to a second side and having a back wall and a front wall, the first side of the front wall having a recessed area, the second side including a mounting section to receive a wood board.

### BRIEF DESCRIPTION OF THE DRAWINGS

FIG. 1 shows a cross sectional profile of a pultruded door frame for headers and jambs, in accordance with one embodiment.

FIG. 2A shows a cross sectional profile of the pultruded door frame of FIG. 1 with a trim and wood insert, in accordance with one embodiment.

FIG. 2B shows a cross sectional profile of the pultruded door frame of FIG. 1 with a main door and a screen door attached, in accordance with one embodiment.

FIG. 3 shows a perspective view of the pultruded door frame of FIG. 1.

FIG. 4 shows another perspective view of the pultruded door frame of FIG. 1.

FIG. 5 shows a perspective view of a pultruded door frame, in accordance with one embodiment.

FIG. 6 shows a cross sectional profile of the pultruded door frame of FIG. 5, in accordance with one embodiment.

FIG. 7 shows a perspective view of a pultruded door frame, in accordance with one embodiment.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined or that other embodiments may be utilized and that structural changes may be made without departing from the spirit and scope of the present invention. The following detailed description is, therefore, not to be taken in a limiting sense, and the scope of the present invention is defined by the appended claims and their equivalents.

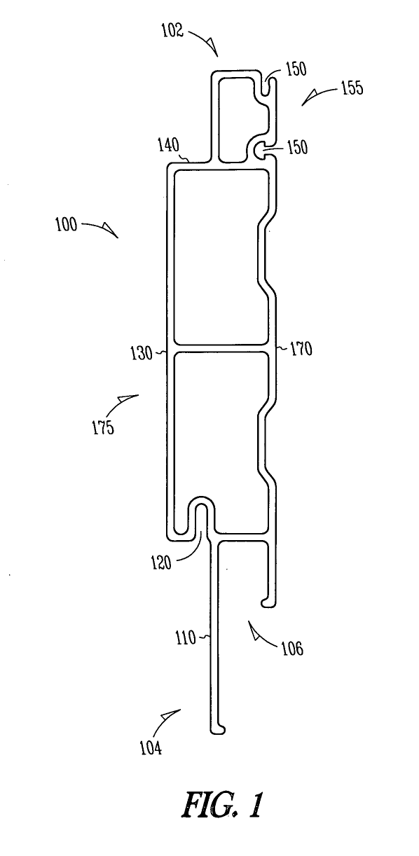

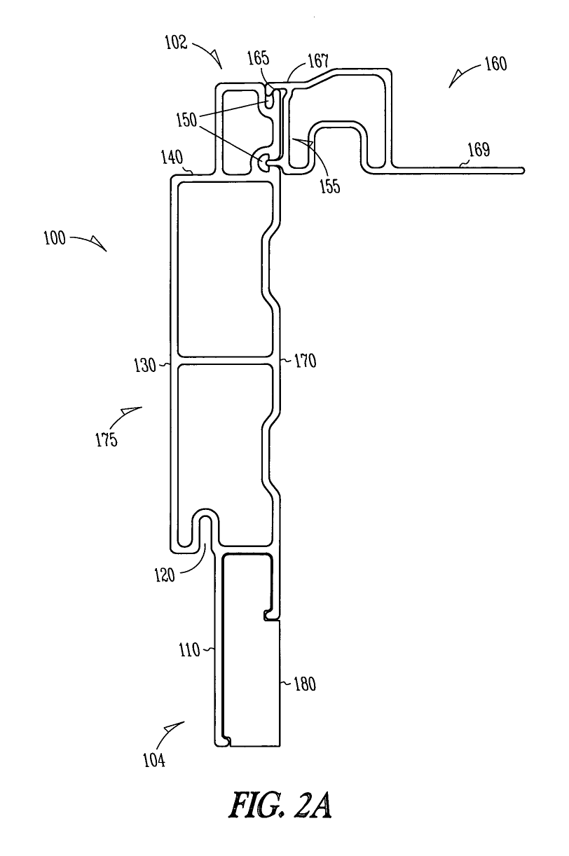

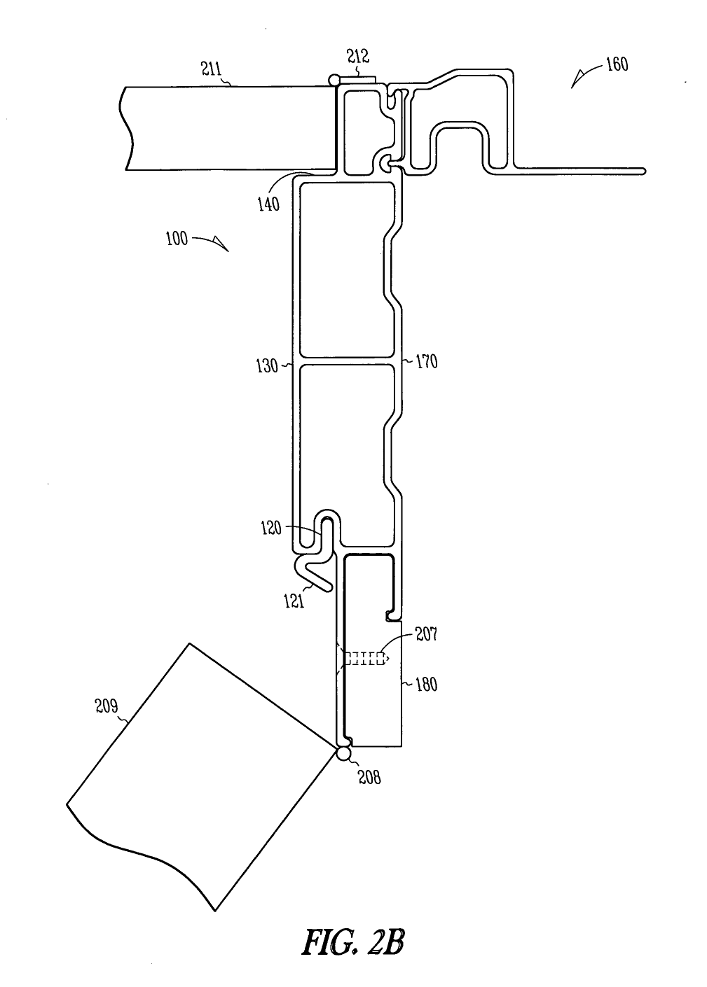

FIG. 1 shows a cross sectional profile of a pultruded door frame 100 for headers and jambs, in accordance with one embodiment and FIG. 2A shows a cross sectional profile of pultruted door frame 100 with a brickmold trim piece 160 and a wood board insert 180 for interior trim and hinge attachment.

Frame 100 can be utilized as an entry door frame and generally includes a pultruded profile extending from a first side 102 to a second side 104 and having a back wall 170 and a front wall 175 including an interior portion 110 and an exterior jamb section 130. The first side 102 of the front wall 175 includes a recessed area 140. Recessed area 140 provides a space for screen door or storm door attachment. Second side 104 includes a mounting section 106 to receive wood board 180. In one embodiment, wood board 180 is inserted into the interior side of the pultruded jamb and header to serve as an attachment point for hinge screws and interior trim. Entry door frame 100 can also include a kerf detail defining a weather strip mounting area 120 for weather-stripping attachment.

The back wall 170 proximate the second side 102 includes a mounting area 155 adapted to receive a trim piece 160. For example, brickmold trim piece 160 attaches at attachment points 150. In this example, attachment points 150 include a snap fit mounting section 165. Trim piece 160 includes a mating wall 167 that snap fits into upper attachment point 150. Trim piece 160 can have assorted profiles and can be a pultruded member. In some embodiments, trim piece 160 can be an aluminum member. Trim piece 160 can include a nailing fin 169.

FIG. 2B shows a cross sectional profile of pultruded door frame 100 with a main door 209 and a screen door 211 attached, in accordance with one embodiment. For example, a hinge 212 of screen door 211 can be attached to the outer surface of frame 100 and a hinge 208 of door 209 can be attached by a screw 207 into wood 180. A weather strip 121 fits within mounting section 120.

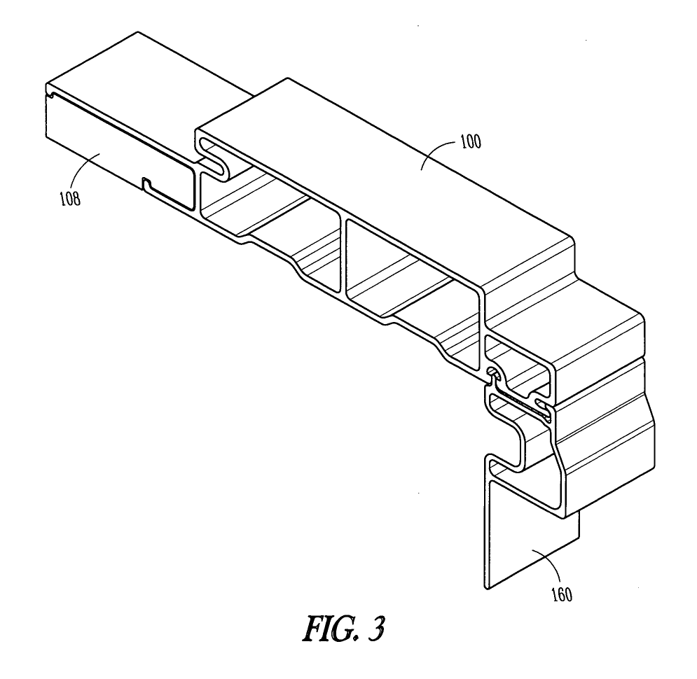

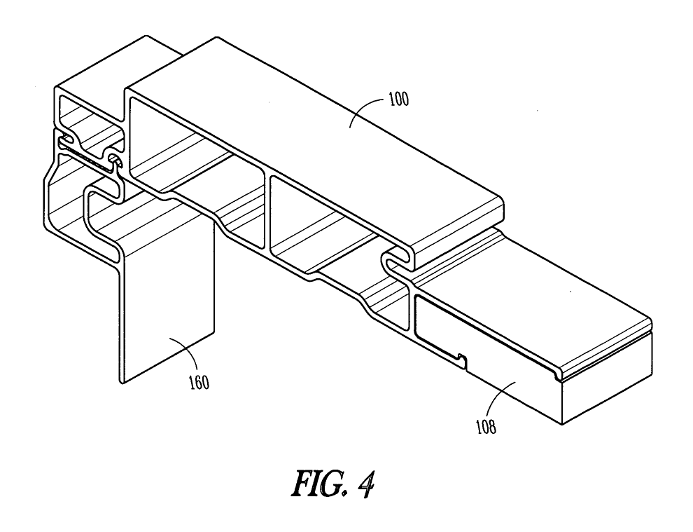

FIGS. 3 and 4 show perspective views of frame 100 with brickmold trim piece 160 and wood insert 180.

Pultruded profiles, such as frame 100, are known for their strength, rigidity, low thermal conductivity, low coefficient of thermal expansion (CTE), high heat deflection temperature (HDT), among other properties.

In one embodiment, the interior section 110 of frame 100 allows for a maintenance-free finished wall to replace the primed wood section of conventional door frames. An aluminum interior section would need to be thermally broken from the rest of the profile to reduce heat transfer between the interior and exterior of the building. Pultruded profile 100 featuring finished interior feature 110 allows for an aesthetically pleasing finished surface without painting, repeated maintenance, or thermal breaks. This finished interior feature 110 eliminates the need for field painting, which requires the removal the weather-strip and manual painting of the primed wood by the homebuilder. The finished interior feature 110 is substantially the same thickness as the hinge, allow for a alignment and flush mounting of the hinge after a hinge pocket is routed into the finished interior feature 110.

The overall profile 100 can replace wood, aluminum clad wood, PVC, or cellular PVC currently used in door frames. The pultruded profile 100 is not be susceptible to rot, termites, moisture swelling, or repeated repainting like wood frames. The pultruded profile 100 is not be susceptible to thermal transfer issues of aluminum, allowing for a full frame piece that constitutes the interior, exterior and depth (not just a cladding) of the door frame. The pultruded profile 100 can be stronger, stiffer, and non susceptible to high expansion and contraction with temperature extremes (CTE) or loss of strength (HDT) at high temps like PVC and cellular PVC.

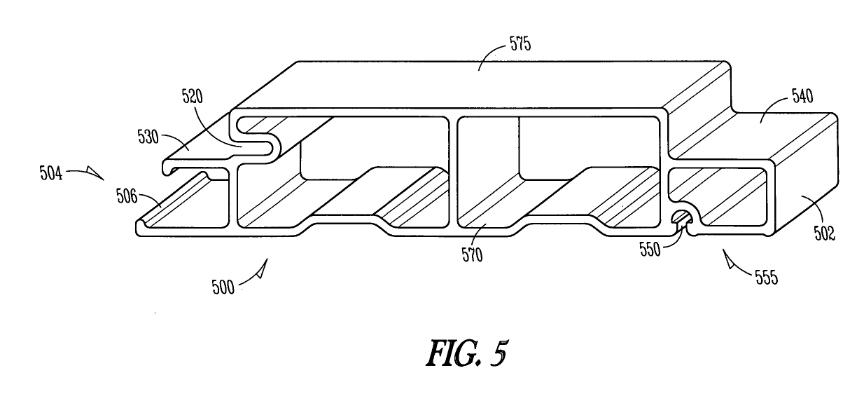

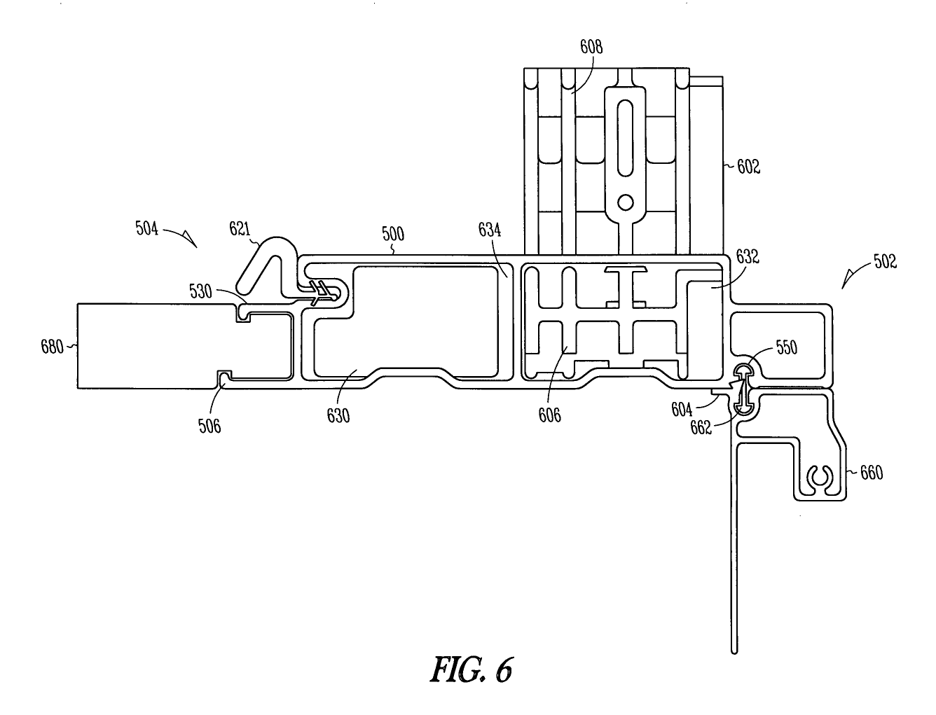

FIG. 5 shows a perspective view of a pultruded door frame 500, in accordance with one embodiment. FIG. 6 shows a cross sectional profile of pultruded door frame 500, in accordance with one embodiment. Certain details of frame 500 are similar to frame 100 and will be omitted for sake of brevity.

Frame 500 can be utilized as an entry door frame and generally includes a pultruded profile extending from a first side 502 to a second side 504 and having a back wall 570 and a front wall 575. The first side 502 of the front wall 575 includes a recessed area 540. Recessed area 540 provides a space for screen door or storm door attachment. Second side 504 includes a mounting section 506 to receive wood board 680. In one embodiment, wood board 680 can be inserted into the interior side of the pultruded jamb and header to serves as an attachment point for hinge screws and interior trim. In this example, a top wall 530 of mounting section 506 does not extend over the entire surface of wood board 680, thus a user can stain or paint the wood board surface as desired. Frame 500 can be used as an entry door frame and has a width of about 6 9/16 inches, for example.

Entry door frame 500 can also include a kerf detail defining a weather strip mounting area 520 for weather-stripping 621 attachment.

The back wall 570 proximate the second side 502 includes a mounting area 555 adapted to receive a trim piece 660. For example, brickmold trim piece 660 attaches at recessed attachment point 550 using a mounting member 604 such a dog-bone shaped piece. Trim piece 660 includes a corresponding recess 662 for attachment to the mounting member 604.

In one embodiment, a door frame system includes a corner key 602 dimensioned to fit within an end 632 of the pultruded frame member 500 to align and/or mount pultruded frame member 500 to a second pultruded frame member. The corner key fits into the end of each pultruded frame member and helps align and mount the members together at their ends, which have a 45 degree angle. For example, the corner key 602 can include an L-shaped member with a first leg 606 of the L-shape extending into an end of pultruded frame member 500 (outward from FIG. 6) and a second leg 608 of the L-shape extending into an end of a second pultruded frame member positioned substantially perpendicular to the first pultruded frame member.

In one embodiment, a door frame can include a sill key 630 mountable within the pultruded frame member 500 and adapted to mount to a sill. In other embodiments, a sill can be screwed in from the sides to attach the sill to the door frame.

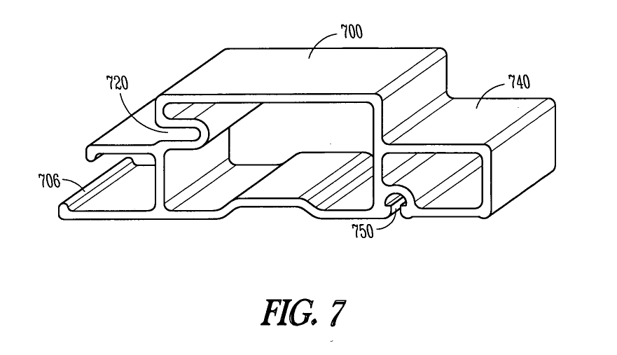

FIG. 7 shows a perspective view of a pultruded door frame 700, in accordance with one embodiment. Certain details of frame 500 are similar to frame 100 and will be omitted for sake of brevity. In this example, frame 700 generally includes a pultruded profile extending from a first side 702 to a second side 704 and having a back wall 770 and a front wall 775 including an interior portion 710 and an exterior jamb section 730. The first side 702 of the front wall 775 includes a recessed area 740. Recessed area 740 provides a space for screen door or storm door attachment. Second side 704 includes a mounting section 706 to receive wood board 780. In another embodiment, wood board 780 is inserted into the interior side of the pultruded jamb and header to serves as an attachment point for hinge screws and interior trim. Entry door frame 700 can also include a kerf detail defining a weather strip mounting area 720 for weather-stripping attachment. The back wall 770 proximate the second side 702 includes a mounting area 750 adapted to receive a trim piece, such as discussed above. Frame 700 can be used as an interior door frame and has a width of about 4 9/16 inches, for example.

In some embodiments, door frames such as discussed above are pre-hung and install quickly and easily. In some embodiments, the door frame can be delivered to the user pre-fabricated and ready to assemble with jambs and headers cut to length and hinge routes and strike routes all completed.

Referring to the above Figures, one method of constructing a door frame includes mounting a first corner key to one end of a first pultruded door frame member, such as a 7.5 foot length of member 100. A second pultruded door frame member is mounted substantially perpendicular to the first pultruded door member with the corner key mounted to one end of the second pultruded door frame member. The second door frame member and the first door frame member each have 45 degree angle ends so the ends meet flush. A second corner key is mounted to a second end of the second pultruded door frame member and then a third pultruded door frame member is mounted substantially perpendicular to the second pultruded door frame member with the second corner key mounted to one end of the third pultruded door frame member. The door frame can then be mounted to the doorway rough opening. The method can also include mounting a door to the wood board, mounting a screen door or a storm door to the recessed area, mounting a pultruded trim brick mold piece to each of the pultruded door frame members, and mounting a weather strip to each of the pultruded door frame members.

In some embodiments the door frame profiles discussed above are pultruded and formed as a composite part. For example, glass, or other reinforcing fibers, are impregnated with resin and pulled through a forming guide and a heated die. The forming guide orients the fibers to be properly placed in the heated die to insure that the pultruded part has uniform reinforcement across its shape. The heated die cures and/or solidifies the resin around the reinforcing fibers, thus forming the composite part. The composite part, having a profile shape, is continuously pulled out of the heated die by a puller. The puller can be a clamp and stroke action from a reciprocating puller, or a smooth action from a caterpillar puller.

Reinforcing fibers used in the example pultrusions can be glass, carbon fiber, kevlar, and other organic and inorganic filaments and fibers. Reinforcement fibers can take the form of filament and strand bundles, called rovings. They also take the form of yarns, texturized yarns, chopped strand mats, continuous strand mats, knitted mats, woven mats, surfacing veils, and many hybrid combinations of rovings, yarns, mats, and veils.

Resin used in example pultrusions can be thermosetting resins like unsaturated polyesters in a styrene solution, or polyurethanes, phenolics, epoxides, thermosetting blends, and other thermosetting resins. Other resins used in pultrusion can be thermoplastic resins based on polyurethanes, acrylics, polyethylenes, and other thermoplastic resins. Resin used in pultrusion can also be thermoplastic resins that are embedded in rovings that melt and form the part inside the pultrusion die.

Resin mixtures in pultrusion can also contain organic, polymeric, and inorganic additives for such properties as shrink control, mold lubrication, colorants, fillers and other specially additives.

In some embodiments, surfaces of any of the pultruded profiles can include a coating such as described in U.S. Pat. No. 6,197,412, which is incorporated herein by reference in its entirety. For example, a thermoplastic compound film, such as an acrylic film can be applied to the exposed surfaces of a pultruded door frame.

The above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. An door frame comprising:
a pultruded profile extending from a first side to a second side and having a back wall and a front wall, the front wall proximate the first side having a recessed area, the second side including a mounting section to receive a wood board.

2. The door frame of claim 1, wherein the back wall proximate the second side includes a mounting area adapted to receive a trim piece.

3. The door frame of claim 2, wherein the mounting area adapted to receive the trim piece includes a snap-fit mounting section.

4. The door frame of claim 2, wherein the mounting area adapted to receive the trim piece includes a recess shaped to receive a mounting member such that the trim piece is mounted to the mounting member.

5. The door frame of claim 1, wherein the second side includes a mounting section to receive a length of weather strip.

6. The door frame of claim 1, wherein the recessed area is adapted to receive a storm door or a screen door.

7. An door framing system comprising:
a pultruded frame member extending from a first side to a second side and having a back wall and a front wall, the front wall proximate the first side having a recessed area for screen door or storm door attachment, the second side including a wood board mounting section, the second side including a mounting section to receive a length of weather strip;
a wood board mounted to the wood board mounting section; and
a weather strip mounted to the weather strip mounting area.

8. The system of claim 7, wherein the back wall proximate the second side includes a trim piece mounting area and the system further includes a trim piece mountable to the trim piece mounting area.

9. The system of claim 8, wherein the trim piece mounting area is adapted to receive the trim piece by a snap-fit.

10. The system of claim 8, wherein the trim piece mounting area includes a recess shaped to receive a mounting member such that the trim piece is mounted to the mounting member.

11. The system of claim 7, further including a corner key dimensioned to fit within an end of the pultruded frame member to align the pultruded frame member to a second pultruded frame member.

12. The system of claim 11, wherein the corner key includes an L-shaped member.

13. The system of claim 7, further including a sill key mountable within the pultruded frame member and adapted to mount to a sill.

14. A method comprising:
mounting a first corner key to one end of a first pultruded door frame member;
mounting a second pultruded door frame member substantially perpendicular to the first pultruded door member with the corner key mounted to one end of the second pultruded door frame member;
mounting a second corner key to a second end of the second pultruded door frame member; and
mounting a third pultruded door frame member substantially perpendicular to the second pultruded door frame member with the second corner key mounted to one end of the third pultruded door frame member.

15. The method of claim 14, wherein each of the door frame members includes a profile extending from a first side to a second side and having a back wall and a front wall, the front wall proximate the first side having a recessed area, the second side including a mounting section to receive a wood board.

16. The method of claim 15, further including mounting a door to the wood board.

17. The method of claim 15, further including mounting a screen door or a storm door to the recessed area.

18. The method of claim 14, further comprising mounting a pultruded trim mold piece to each of the pultruded door frame members.

19. The method of claim 14, further including mounting a weather strip to each of the pultruded door frame members.
